(19) United States
(12) Patent Application Publication
(10) Pub. No.: US 2009/0203407 A1
(43) Pub. Date: Aug. 13, 2009

(54) IMPLEMENTING CALLING RESTRICTIONS BETWEEN COMMUNICATION NETWORKS

(75) Inventors: Anand B. Alen, Flower Mound, TX (US); Jheroen P. Dorenbosch, Paradise, TX (US); Lowell C. Hufferd, Keller, TX (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/029,488

(22) Filed: Feb. 12, 2008

(51) Int. Cl. H04Q 3/70

(52) U.S. Cl. 455/565

(57) ABSTRACT

An apparatus and method for implementing calling restrictions between communication networks includes a first step of defining call control parameters in a repository. A next step includes initiating a call from the first network via a gateway for a target identifier in the second network. A next step includes making a query to download a text record of the call control parameters from the repository. A next step includes downloading the set of call control parameters in a text record by the gateway. A next step includes restricting the call from the first network to the second network by the gateway in accordance with the set of call control parameters.

### FIELD OF THE INVENTION

The present invention relates in general to communication networks, and more specifically, to a method and system for implementing calling restrictions between communication networks.

### BACKGROUND OF THE INVENTION

Today's wireless communication systems provide a broad range of services to individual subscriber units and groups of subscriber units, while either stationary or mobile. These services include, but are not limited to, cellular telephony, group dispatch, and packet data communication, to name a few. Examples of typical standardized wireless communications systems include, for example Global System for Mobile Communication (GSM) and later generations of GSM such as GPRS, UMTS, LTE, Code Division Multiple Access (CDMA) and later generations of CDMA, Trans-European Trunked Radio (TETRA) systems, WiFi, WiMax and the like. There are also various proprietary communication systems such as, for example, the Integrated Digital Enhanced Network (iDEN™) or SMARTZONE™ systems, which are available from Motorola, Inc. at 1301 East Algonquin Road Schaumburg, Ill. 60196.

Some of the above systems provide unique service functionality (e.g. dispatch Push-to-Talk (PTT) in the iDEN™ system) that operators of other communication systems (e.g. CDMA) wish to emulate or port to their systems. In the above example, the process of migrating iDEN subscribers to a CDMA communication system enables CDMA PTT subscribers to dispatch iDEN PTT subscribers. In addition, there may be service agreements between two service providers such that subscribers of either service provider can roam between the two respective networks and PTT each other. However, existing communication systems provide little functionality for one service provider to prevent another service provider's subscriber from using its system to contact its subscribers. In other words, there is no way for the system A to prevent system B PTT subscribers from communicating with system A PTT subscribers that are located within the system A. Further, where there are roaming agreements between systems A and B, and systems B and C, but not systems A and C, there is no way to prevent system C subscribers from roaming into system B and communicating with system A subscribers. In short, the above examples outline a problem of having no calling restrictions between communication networks.

Calling restrictions have been implemented in other cellular and land line systems. For example, Push-to-Talk over Cellular (PoC) has white and black lists for individual users. These lists define specific authorized or unauthorized users of the PoC system. In addition, the iDEN™ system has long distance calling restrictions, but those restrictions are based on a location of users, such as within a particular city. Each of these solutions is unique to that particular communication system. None of these solutions provide a universal technique that can be applied across various different communication protocols.

In accordance with the foregoing, there exists a need for method and system for implementing calling restrictions between different communication networks. Such a system should be implemented to minimize network connection processing and overhead and be applicable to various communication systems. In addition, such a system should applicable to various user services such as PTT, voice, data, text, and video, for example.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates a two communication networks, wherein various embodiments of the present invention can be practiced;

FIG. 2 is a flow diagram illustrating an exemplary flow of instructions for implementing calling restrictions between communication networks, in accordance with various embodiments of the present invention; and

FIG. 3 is a flow chart illustrating a method for implementing calling restrictions, in accordance with various embodiments of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION OF THE EMBODIMENTS

Before describing in detail the particular method and system for implementing calling restrictions between communication networks, in accordance with the present invention, it should be observed that the present invention utilizes a combination of method steps and apparatus components that are related to the method and system for implementing calling restrictions between communication networks. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

As used herein, the terms such as user equipment (UE) or communication device generally refer to an end user device such as a fixed or/and mobile SIP phone, cellular or mobile radiotelephone, WiMAX SIP user agent, two-way radio, messaging device, personal digital assistant, personal assignment pad, a personal computer equipped for wireless operation, a cellular handset or device, or the like, or equivalents thereof provided such units are arranged and constructed for operation in accordance with the various concepts and principles of the present invention and operating under appropriate specifications, standards, and protocols as discussed and described herein. It should be noted that the present invention is applicable to any type of access that provides an IP network layer.

The principles and concepts discussed and described may be particularly applicable to communication units, devices, radio access networks and systems providing or facilitating packet based communications services or voice, data, or messaging services over communication networks, such as conventional two way systems and devices, various cellular phone systems including analog and digital cellular, CDMA (code division multiple access) and variants thereof, GSM (Global System for Mobile communications), GPRS (General Packet Radio System), 2.5 G and 3 G systems such as UMTS (Universal Mobile Telecommunication Service) systems, a CDMA Data Only (DO) system, a High Rate Packet Data Access (HRPDA) system, a Wireless Local Area Network (WLAN) system, a CDMA Evolution Data Voice (EVDV) system, and Integrated Digital Enhanced Networks, and variants or evolutions thereof. The principles and concepts described herein may further be applied in devices or systems with shorter range communications capabilities, such as IEEE 802.xx, Bluetooth, WiFi or WiMAX and the like that preferably utilize CDMA, frequency hopping, orthogonal frequency division multiplexing, or TDMA access technologies and one or more of various networking protocols, such as Session Initiation Protocol (SIP), Session Description Protocol (SDP), Real Time Transfer Protocol/Universal Datagram Protocol (RTP/UDP), TCP/IP (Transmission Control Protocol/Internet Protocol), IPX/SPX (Inter-Packet Exchange/Sequential Packet Exchange), Net BIOS (Network Basic Input Output System) or other protocol structures. It should be noted that the different communication networks may use the same or different communication technologies.

Further in accordance with various exemplary embodiments, the present invention can be implemented as a higher layer, such as application layer software application, in which case lower protocol layers, such as the data link layers, can be interchangeable without departing from the intended scope of the invention, provided they support packet switched communication.

The present invention provides a method and system for implementing calling restrictions between different communication networks. Such a system is implemented to minimize network connection processing and overhead and is applicable to various communication systems. In particular, the networks may use the same technology or different technologies. The present invention is described herein in terms of PTT communications between different communication networks. However, it should be noted that the present invention is applicable to various user services such as PTT, voice, data, text, and video, and the like.

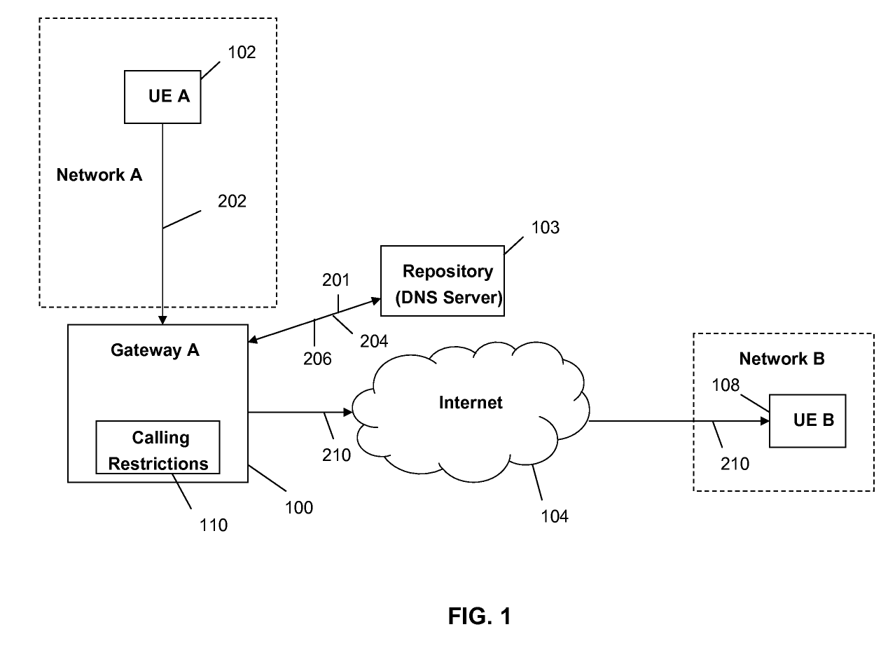

With reference to FIG. 1, the system 200 of the present invention is operable for two (as shown) or more communication networks at least one of which supports Internet Protocol (IP) addressing of packets to provide voice, data, text, group or dispatch call service. The present invention also provides a call set-up methodology optimized for use in packet communication systems that support the same user services above. In the example shown, user equipment (UE A) 102 and Gateway A 100 comprise communication network A, and user equipment (UE B) 108 is included in communication network B which represents one or more different networks that could communicate with communication network A. It should be noted that each communication network comprises various other network elements such as call controllers, application servers, databases and operator interface terminals, which are not shown for the sake of brevity, and typically serves a large number of other UEs, which are also not shown. The system includes Wide Area Network (WAN) or an Internet connection 104 between communication networks A and B and allows access to a repository 103, such as a Domain Name System (DNS) server. As described herein, communications in the system operate using SIP/SDP protocols, as are known in the art.

The gateway 100 includes a processor (such as, for example a microprocessor, micro-controller, digital signal processor or some combination thereof) and a memory (such as volatile or non-volatile digital storage devices or some combination thereof) suitable to download call control parameters (e.g. calling restrictions) 110. The call control parameters can be downloaded to the gateways from the DNS server, or any other repository 103, or any other network entity, and even from other gateways, such as from communication network B. The call control parameters, in particular, consist of one or more tables containing identifications of allowed and/or restricted calls between users. The gateway can also download tables of domain names and server-to-domain maps for use in the present invention. These domain/server tables can also be downloaded to the gateway from the DNS server, or any other network entity, and even other gateways.

As will be appreciated, a subscriber UE 102 in a network (e.g. A) can communicate, via wireless and wired communication resources, through the gateway 100 to any other subscriber UE 108 in one or more other communication networks (e.g. B), which may comprise mobile or portable wireless radio units. It should be recognized that the wireless communication resources may comprise any of the currently available resources, such as, for example, radio frequency (RF) technologies, including, but not limited to Code Division Multiple Access (CDMA), Time Division Multiple Access (TDMA), Frequency Division Multiple Access (FDMA), and the like. Moreover, the present invention may be used in any of the currently available Radio Frequency (RF) communication systems, such as, for example, Global System for Mobile communication (GSM), General Packet Radio Service (GPRS), Universal Mobile Telecommunications Service (UMTS), Trans-European Trunked Radio service (TETRA), Association of Public Safety Communication Officers (APCO) Project 25, Personal Communication Service (PCS), Advanced Mobile Phone Service (AMPS), and the like. In the alternative, other wireless technologies, such as those now known or later to be developed and including, but not limited to, infrared, Bluetooth, electric field, electromagnetic, or electrostatic transmissions, may likewise suffice.

Practitioners skilled in the art will appreciate that the system shown in FIG. 1 is greatly simplified for the sake of simplicity, and will include various other wireline and/or wireless communication devices not specifically shown, but known in the art. For example, packet communications can be connected to a gateway through a base station and radio access network controller. The gateway can also be connected to a number of additional content sources, such as the Internet (as shown) or various Intranets. In support thereof, the present invention can include any number or type of wire line communication device, site controller, comparator, repeater, telephone interconnect device, internet protocol telephony device, router, and the like, collectively referred to herein as a fixed devices. It should be noted that the communication networks can be connected via a single gateway. For example, the gateway 100 may communicate directly with the network elements in network A and directly with the network elements in network B, thus enabling a subscriber UE 102 in network A to communicate with another subscriber UE 108 in network B. Alternatively, the gateway 100 may communicate directly with the network elements in network A and with the network elements in network B via a second gateway (not shown) associated with network B, thus enabling a subscriber UE 102 in network A to communicate with an other subscriber UE 108 in network B via the gateway A 100 and via a network B gateway. The gateway 100 may also be implemented as a controller that is separate from, and not comprised in the communication networks A or B. Such a separately-implemented gateway may communicate with the network elements in communication network A and/or communication network B via a firewall, another gateway, and/or another interworking function that provides protocol conversion. In any of the above implementations the gateway 100 connects different communication networks and supports the initiating of a call from UE A 102 in communication network for a target UE B 108 in communication network B.

The present invention makes call restrictions and/or allowances based upon UE source or destination identifier, home network or location. As is known in the art, there are various techniques to determine the identifier or location of any particular UE within a communication system. For example, when SIP protocol is used for call setup, the identifier of the originator UE and the target UE typically appear on one of the headers of the call setup request. Since the determination, storage, and retrieval of subscriber location or identifier information is well within the knowledge of those skilled in the art, it will not be discussed here in detail, other than mentioning that this information is to be obtained using software routines and/or programs stored within a gateway of the system, where applicable.

As will be appreciated by those skilled in the art the identifier or location relationship between particular UEs and gateways can be static or dynamic and is typically a function of subscriber location or registration. Association concepts available for use in the current invention include, but are not limited to, home versus roaming domains and servers, and a UE identifier such as its Universal Fleet Member Identifier (UFMI) and a phone number.

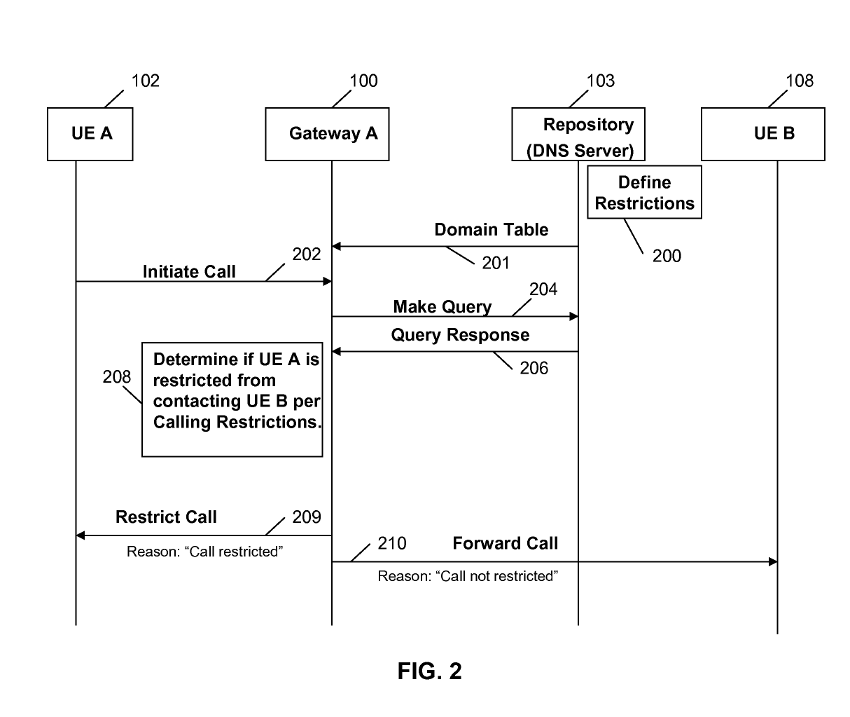

With reference to FIGS. 1 and 2, an attempted call from UE A (the source, originating or initiating UE) to UE B (the target UE) will now be described, in accordance with the present invention. UE A 102 using a source identifier of UE A initiates a call 202 to UE B 108 using a target identifier of UA B such as the UFMI of UE B. UE A may be in a wireless or wireline environment of communication network A. For example, UE A 102 may be an iDEN™ subscriber wishing to communicate with a remote CDMA subscriber or iDEN™ subscriber in a remote CDMA or iDEN™ system (i.e. communication network B). As a result, a request to initiate the call is sent 202 to Gateway A 100. The request includes the identifiers of UE A 102 and UE B 108 as the source and the target identifiers and allows the gateway A 100 to identify the current communication network (network A) and/or location of UE A 102.

In the prior art, Gateway A 100 would decide which server on the remote network it is going to “invite” for that call based on the target identifier (e.g. the UFMI dispatch identifier), inasmuch as Gateway A has a known process to determine where to send a call request for target identifier of UA B 108. For example, the gateway A may use a range of target UFMIs pre-configured therein to point to a Fully Qualified Domain Name (FQDN) of a server where the gateway can send call requests for target identifiers comprised in that range. Gateway A would then forward the call setup request and send a SIP INVITE message 210 to that server to complete the call connection. However, the present invention has Gateway A perform a restriction analysis before any message 210 can be sent, as will be detailed below.

In accordance with the present invention, a set of calling control parameters or calling restrictions are predefined 200 in a repository, such as a DNS server, that serves the affected gateway A 100. These calling control parameters are available to restrict and/or allow calls between UEs. Although the calling parameters are initially defined in a repository, such as the DNS server, they may become available to any network entity in either network and other gateways, such as a gateway for network B (not shown). These can be delivered 201 to the gateway 100 upon a specific request, a previous receipt for another call, or as part of the power up procedures of the Gateway A 100.

Upon receipt of a call request 202, Gateway A 100 makes a query 204 to download a text record having new information about call restriction (and/or allowance) parameters. The query 204 preferably is a DNS text (DNS TXT) query. The calling control parameters are able to restrict and/or allow a call between networks for the UEs A 102 and B 108 as well as for calls between other UEs associated with communication networks A and B and with other communication networks.

In making the query 204, Gateway A 100 can include a configured parameter that identifies Gateway A 100. This configured parameter could be used to return different portions of call control parameters 206 to different Gateways, if these portions are only relevant to that identified gateway, thereby reducing the size of the response to the query. For example, if a DNS repository is being used, a gateway A 100 with the name XYZ may include the identifier XYZ in the query as the domain name and perform a query as shown in the example of Table 1 below:

TABLE 1
Example Query

```
    Query ID = 22334
    Opcode: Query
    RD (Recursion Desired)
    1 question(s)
    Domain Name: call-constraint.XYZ
    Class: 1 (Internet)
    Type: 16 (Text strings)
while the repository is provisioned with a record that contains the same
parameter XXX as ORIGIN information as follows:
    $ORIGIN XYZ
    $TTL 3600
    @ IN  SOA  itexdns-1.com. hostmaster (1465947 7200 3600
    3600000 60)
  NS  itexdns-1.com.
  call-constraint IN TXT “...”
  call-constraint IN TXT “...”
  ...
```

Other information could also be returned to the Gateway as the result of a query, including a Domain Table that specifies the home domain for a given UFMI range, or a Server Table that maps servers in a domain (their FQDNs) to their higher level domain name. Alternatively, the gateways may receive 201 the Domain Table and/or Server Table separately (as shown) from the call control parameters. The Domain, Server, and other call control parameters are expected to be defined in a DNS server, but can be defined in any repository or network entity accessible by the gateways. In this way, the call control parameters can be independently managed at each gateway since different gateways may use different restrictions. For example, Gateway A 100 may restrict calls to network B, but a gateway in network B 106 may not restrict calls from Gateway A 100. In any event, at least the call control parameters are returned 206 to the requesting gateway in at least one text record. In particular, the DNS server answers the DNS TXT query with a DNS query response including a text record containing a table of the call control parameters and possibly a Domain Table and/or Server Table.

As used herein, the Domain Table specifies the home domain for a given identifier range, such as a UFMI range. It should be noted that a UFMI identifier number actually consists of three parts, an urban identifier U, a fleet identifier F, and a member identifier MI. To apply the invention to UFMIs, the concept of UFMI ranges is introduced. To define a range for UFMIs, a notation needs to be defined for UFMIs and one needs to define meanings of “equal” and “greater than”. A notation can be defined as follows: A UFMI of Ua*Fa*MIa has a U value of Ua, a F value of Fa, and a MI value of MIa. An equality definition can also be defined that states UFMI Ua*Fa*MIa is equal to UFMI Ub*Fb*MIb if and only if (Ua=Ub) AND (Fa=Fb) AND (MIa=MIb). A “greater than” definition can be defined as UFMI Ua*Fa*MIa is greater than UFMI Ub*Fb*MIb if (Ua is greater than Ub) OR ((Ua=Ub) AND (Fa is greater than Fb)) OR ((Ua=Ub) AND (Fa=Fb) AND (MIa is greater than MIb)). In other words, U is the ‘most-significant’ field and MI is the ‘least-significant’ field. A UFMI “range” definition can be defined using the definitions above and specifying endpoints Ua*Fa*MIa and Ub*Fb*MIb. A UFMI is in that range if the UFMI is greater or equal to Ua*Fa*Mia AND if Ub*Fb*MIb is greater or equal to the UFMI. For the purpose of simplification, the present invention represents the UFMI as a simple numeric value as shown in Table 1. However, it should be recognized that the ranges of any of the various three parts of the UFMI, in combination or alone, could be used as the basis for defining UFMI ranges. Such UFMI ranges can then be used to define properties and restrictions for the UEs with UFMIs that fall within those ranges. For example, one may use UFMI ranges, or ranges of other identifiers to define where UEs with such UFMIs or identifiers are homed, which server serves the UEs' domain and what call restrictions or allowances may apply to the UEs. Table 2 provides an example Domain Table that specifies where UEs with an identifier that falls with certain identifier ranges are homed. The example table shows that there are three communication networks, each pre-assigned with a range of UFMIs.

TABLE 2
Example Domain Table

| UFMI range | Network |
|---|---|
| 100-199 | networkA.com |
| 200-299 | networkB.com |
| 300-399 | networkC.com |

Therefore, a UE having a UFMI of 137, is within the UFMI range of 100-199 and would be recognized as homed in or belonging to communication network A. A UE is said to be homed in a domain if that domain is the home domain of the UE. Typically that implies that that domain contains the UE's provisioning and location database, such as the UE's Home Location Register (HLR), the UE's iDEN HLR (iHLR), the UE's Home Subscriber Server (HSS), or the UE's SIP registrar.

Server Tables are known in the art, as described in RFC 3263 for example, and the information in a Server Table maps servers in a domain (their FQDNs) to their higher level domain name. For example, “sipserver1.east.networkA.com” would be identified as a server in the “networkA.com” domain. When calls are made, the server that's being targeted or the server that originated the call is specified, for example, in SIP headers. The Server Table along with server information from the headers is used to implement server based restrictions in the present invention as described below.

In accordance with the present invention, the call control parameters (e.g. the Restrictions Table) are preferably incorporated into a table as text records and dictate who can initiate a call to whom. This table can be used to convey allowed calls or restricted calls. As described below, calls that are only restricted by the call control parameters are used as an example.

The present invention envisions various formats proposed to convey restriction (and/or allowance) information. However, it should be recognized that the present invention is not limited to the examples below, and that the present invention encompasses all comparison techniques that can be envisioned using call control parameters to restrict or allow calls between networks. As described below, restriction formats are organized into location and/or identification restrictions. However, other restrictions may be applied.

Call restrictions and/or allowances are preferably contained in the call control parameters in the form of one or more records. Records may have several formats and several exemplary formats are presented below. To reduce the number of records that must be maintained, the records use ranges of identifiers where each range of identifiers defines a set of UEs. A UE belongs to a range if the identifier of the UE falls within that range. This provides a much more efficient way of storing and manipulating calling restriction information, which normally consists of white-lists and black-lists that contain one or more individual identifiers that each identify only a single UE or group. A first example record has the following format:

Format 1: EX: From 200-299 To 300-399

In this format, two ranges of identifiers are used to specify call restrictions. Here the characters ‘EX’ denote ‘Exclude’. UEs that have an identifier in the first identifier range of 200 to 299 cannot call UEs in the second identifier range of 300 to 399 regardless of where these UEs are homed or where they are currently located, as long as the call is served by the Gateway that applies the restrictions. Restricted UEs may even be in the same network. It should be noted that this format does not preclude UEs with identifiers in the range 300-399 making a call to UEs with identifiers in the range 200-299. If such a mutual restriction is needed then the call control parameters must specify a further configuration of “EX: From 300-399 To 200-299” as an entry in the restriction table. A second example record uses the following format:

Format 2: EX: From user:networkA.com To user:networkB.com

In this format, UEs that are homed in the “networkA.com” domain cannot initiate calls to UEs homed in the “networkB.com” domain. This information about the assignment of UEs to domains can be obtained from the Domain Table. Again, this format does not preclude UEs homed in “networkB.com” initiating a call to UEs home in “networkA.com”. If such a mutual restriction is needed then the call control parameters must specify a further configuration of “EX: From user:networkB.com To user:networkA.com” as an entry in the restriction table.

Format 3: EX From server:networkA.com to server:networkB.com

In this format, originating UEs that are being served by a server of “networkA.com” domain cannot initiate calls to a target UEs being served by a server of “networkB.com” domain regardless of who is using the originating or target UE or where these UEs are homed. This information can be obtained from the Domain and Server Tables. This format addresses roaming and non-roaming users. For example, a Network C UE roaming into Network A space cannot make calls to any UE served by the “networkB.com” domain. Again, this format does not preclude UEs served by “server:networkB.com” initiating a call to a UE served by “server:networkA.com”. If such a mutual restriction is needed then the service provider (DNS server) must specify a further configuration of “EX: From server:networkB.com to server:networkA.com” as an entry in the restriction table.

Format 4: Combination of the above three formats, such as:

EX: From server:networkA.com to user:networkB.com, or
EX: From 200-299 To user:networkB.com.

In this format, a UE operating under a specific identifier range, domain, or server is restricted from calling a UE operating under any other identifier range, domain, or server. For example, the calling restriction record “EX: From server:networkA.com to user:networkB.com” would disallow any one served by Network A to make calls to UEs homed in Network B but will not disallow anyone from calling non-Network B UEs served by Network B servers. A scenario for this could be a Network C UE who has roamed into Network A space and is calling another Network C UE who has roamed into Network B. As before, this format does not preclude the reverse scenario, unless an explicit entry is made therefor in the restriction table.

Another example format allows the specification of calls that are allowed:

### Format 5: AL: From 2200-3299 To 5300-9999

In this format, two ranges of identifiers are used to specify calls that are allowed. Here the characters ‘AL’ denote ‘Allow’. UEs that have an identifier in the first identifier range of 2200 to 3299 are allowed to call UEs in the second identifier range of 5300 to 9999 regardless of where these UEs are homed or where they are currently located, as long as the call is served by the Gateway that applies the allowance.

Format 6: Shortcut token

In this format, by specifying a unique shortcut token or key (e.g. “VV” for “Vice-Versa”) in the restriction table record, the specified restriction is applied in the forward and reverse direction. For example, “EX: From 200-299 To 300-399 VV” is equivalent to the presence of both “EX: From 200-299 To 300-399” and “EX: From 300-399 To 200-299” in the restriction table. This format saves space in the call control parameters.

Format 7: Short forms

In this format, the above formats can be expressed in short forms. For example, “EX: From 200-299” specifies that no UE with an identifier in this range can call anybody (i.e. any other identifier) and “EX: To 300-399” specifies that no UE in this range can receive calls from anybody (i.e. from any other UFMI). Similarly, short forms can be applied to domain or server formats, even those might be overly restrictive.

Referring back to FIGS. 1 and 2, after a determination by the gateway 100 that there is a call restriction applicable to the originating UE 102 and/or target UE 108, the gateway 100 can block the call and optionally inform 209 the originating UE 102, and possibly inform the target UE 108 (not shown) that the call has been restricted. However, if the gateway 100 determines that there is no call restriction applicable to the originating UE 102 and/or target UE 108, the gateway 100 can allow 210 the call to the target UE 108, and proceed with the call setup using SIP protocols that are known in the art, in order to complete the call.

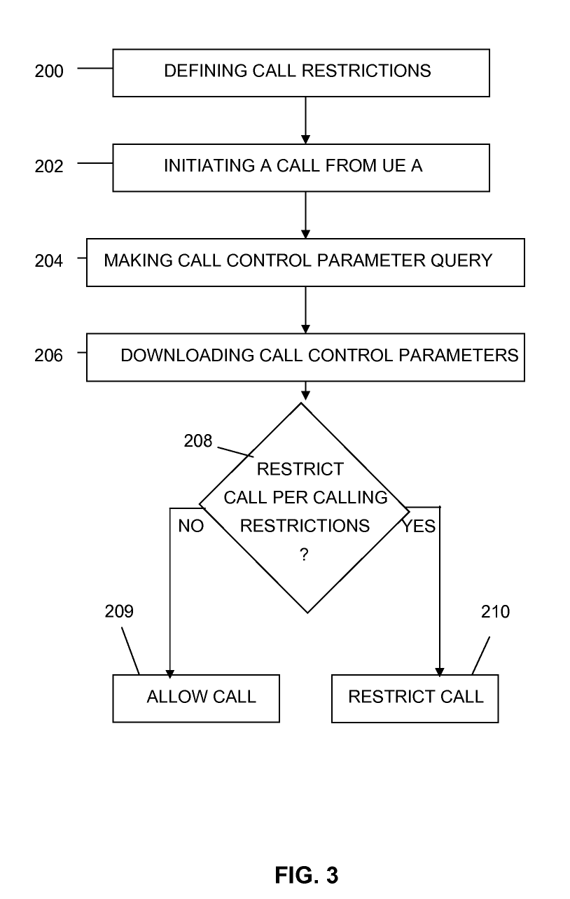

Referring to FIG. 3, the present invention also provides a method for implementing calling restrictions between a first and a second communication network at a gateway. The method includes a first step 200 of defining a set of call control parameters, which can include a Call Restriction and/or a Call Allowance Table. In particular, the set of call control parameters includes at least one text record that defines one or more a call restriction. The call control parameters can also include a Domain Table and/or Server Table as previously described. In particular, the set of call control parameters can include a Domain Table that specifies a home domain for one or more predefined ranges of identifiers (e.g. Universal Fleet Member Identifiers (UFMIs)) of UEs.

A next step 202 includes initiating a call from an originating User Equipment (UE) identified by an originating identifier in the first communication network to the gateway for a target UE identified by a target identifier in the second communication network.

A next step 204 includes making a query, such as a Domain Name System Text (DNS TXT) query from the gateway to a repository (e.g. DNS server) to download the set of call control parameters containing the at least one text record. The step 204 can be made pursuant to step 202, but may also precede it, for example when it is triggered by an earlier call initiation.

A next step 206 includes downloading a resulting set of call control parameters in at least one response (e.g. one or more text records in a DNS query response) by the gateway from the repository (e.g. DNS server). Typically, the set of call control parameters contain one or more ranges of identifiers with corresponding calling restrictions and/or allowances for the one or more ranges of identifiers. The set of call control parameters may also specify calling allowances for one or more ranges of identifiers, servers, or domains.

A next step 208 includes restricting 210 the call from the first communication network to the second communication network by the first gateway in accordance with the resulting set of a call control parameters. The restricting can include the mapping of one or more of the originating identifier and the target identifier on the one or more ranges of identifiers contained in the set of a call control parameters and applying the calling restrictions corresponding to the mapped-on ranges, as previously explained and defined for the different formats below.

Optionally, in the making step 204, the DNS TXT query includes an identification of the gateway, and wherein the downloading step 206 includes downloading the resulting set of calling restrictions specific to the identified gateway.

In a first format, in the defining step 200, the at least one text record includes a restriction/allowance that defines a calling restriction for at least one range of originating UE identifiers and at least one range of target UE identifiers that define sequences of restricted identifiers of UEs, as used in the restricting step 208, 209, to restrict UEs in the first communication network having an originating identifier (e.g. UFMI) that maps to within one specified originating identifier range in the restriction/allowance from calling UEs in the second communication network having a target identifier (e.g. UFMI) that maps to within a specified target identifier range in the restriction/allowance.

In a second format, in the defining step 200, the at least one record includes a restriction/allowance that includes a calling restriction for calls from originating UEs homed in a first specified home domain to target UEs homed in a second specified home domain, as used in the restricting step 208, 209, to restrict originating UEs that are homed in the first specified home domain in the restriction/allowance from calling UEs that are homed in the second specified home domain in the restriction/allowance.

In a third format, in the defining step 200, the at least one record includes a restriction/allowance that includes a calling restriction for calls from originating UEs served by a first specified domain server to target UEs served by a second specified domain server, as used in the restricting step 208, 209, to restrict a call if the originating UE is served by the first specified domain server and the target UE is served by the second specified domain server.

In a fourth format, in the defining step 200, the at least one record includes a restriction/allowance that includes at least one originating UE calling restricting selected from the group of a specified identifier, a specified home domain, and a specified server, and at least one target UE calling restricting selected from the group of a specified identifier, a specified home domain, and a specified server, as used in the restricting step 208, 209, to restrict the call by the gateway if the originating UE is operating under any one of the originating UE calling restrictions and the target UE is operating under any one of the target UE calling restrictions.

In a fifth format, in the defining step 200, the at least one record includes a restriction/allowance having a shortcut key, wherein the shortcut key indicates that a given restriction that applies to a call from a first UE to a second UE also applies in to a call from a second UE to a first UE.

In a sixth format, in the defining step 200, the at least one record includes a restriction/allowance that defines a calling restriction for at least one range of UE identifiers, as used in the restricting step, to restrict the call by the gateway if at least one of the originator identifier and the target identifier maps to within the at least one range of restricted UE identifiers.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. The invention may further include a process with steps, procedures, or the like. Where a plurality of processes or steps are indicated, they may be performed in any order, unless expressly and necessarily limited to a particular order. Steps or processes that are not so limited may be performed in any order. In certain cases, these steps or processes may be repeated a number of time or may loop infinitely as required or until a particular event occurs or the like.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the present invention.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for implementing calling restrictions between a first and a second communication network connected via a gateway, the method comprising the steps of:
defining a set of call control parameters in a repository, the set of call control parameters comprising at least one text record, the at least one text record defining a call restriction;
initiating a call from an originating User Equipment (UE) in the first communication network to the gateway for a target UE in the second communication network;
making a query from the gateway to the repository to download the set of call control parameters;
downloading a resulting set of call control parameters comprising at least one text record by the gateway from the repository; and
restricting the call by the gateway in accordance with the resulting set of call control parameters.

2. The method as recited in claim 1, wherein in the making step the repository is a Domain Name System (DNS) Server and the query is a DNS query, and wherein in the downloading step the resulting set of call control parameters comprises at least one DNS record.

3. The method as recited in claim 2, wherein the query is a DNS text (DNS TXT) query.

4. The method as recited in claim 1, wherein in the making step, the query includes an identification of the gateway, and wherein the downloading step includes downloading the resulting set of call control parameters specific to the identified gateway.

5. The method as recited in claim 1, wherein in the initiating step the originating UE is identified by an originating identifier and the target UE is identified by a target identifier.

6. The method as recited in claim 5, wherein in the defining step, the at least one text record defines a calling restriction for at least one range of originating UE identifiers and at least one range of target UE identifiers, each range defining a sequences of identifiers of UEs, wherein the restricting step includes restricting the call by the gateway if the originating UE identifier maps to within the at least one range of originating UE identifiers and the target UE identifier maps to within the at least one range of target UE identifiers.

7. The method as recited in claim 1, wherein in the defining step, the at least one record includes a calling restriction for calls from an originating UE homed in a first specified home domain to a target UE homed in a second specified home domain, and wherein the restricting step includes restricting the call by the gateway if the originating UE is homed in the first specified home domain and the target UE is homed in the second specified home domain.

8. The method as recited in claim 1, wherein in the defining step, the at least one record includes a calling restriction for calls from an originating UE served by a first specified domain server to a target UE served by a second specified domain server, and wherein the restricting step includes restricting the call by the gateway if the originating UE is served by the first specified domain server and the target UE is served by the second specified domain server.

9. The method as recited in claim 1, wherein in the defining step, the at least one record includes at least one originating UE calling restricting selected from the group of a specified identifier, a specified home domain, and a specified server, and at least one target UE calling restricting selected from the group of a specified identifier, a specified home domain, and a specified server, wherein the restricting step includes restricting the call by the gateway if the originating UE is operating under any one of the originating UE calling restrictions and the target UE is operating under any one of the target UE calling restrictions.

10. The method as recited in claim 1, wherein in the defining step, the at least one record includes at least one record having a shortcut key, wherein the shortcut key indicates that a given restriction that applies to a call from a first UE to a second UE also applies in to a call from a second UE to a first UE.

11. The method as recited in claim 5, wherein in the defining step, the at least one record defines a calling restriction for at least one range of UE identifiers, wherein the restricting step includes restricting the call by the gateway if at least one of the originating UE identifier and the target UE identifier maps to within the at least one range of restricted UE identifiers.

12. A method for implementing calling restrictions between a first and a second communication network connected via a gateway, the method comprising the steps of:
defining at least one set of call control parameters in a Domain Name System (DNS) server, the set of call control parameters comprising at least one text record, the at least one text record defining a call restriction;
initiating a call from an originating User Equipment (UE) identified by an originating Universal Fleet Member Identifier (UFMI) in the first communication network to the gateway for a target UE identified by a target UFMI in the second communication network;
making a DNS query from the gateway to the DNS server to download the set of call control parameters;
downloading a resulting set of calling restrictions in a DNS query response by the gateway from the DNS server; and
restricting the call from the originating UE by the gateway in accordance with the resulting set of a calling restrictions.

13. The method as recited in claim 12, wherein in the making step, the DNS query includes an identification of the gateway, and wherein the downloading step includes downloading the resulting set of calling restrictions specific to the identified gateway.

14. The method as recited in claim 12, wherein in the defining step, the at least one text record defines a calling restriction for at least one range of originating UE UFMIs and at least one range of target UE UFMIs, each range defining a sequences of UFMIs of UEs, wherein the restricting step includes restricting the call by the gateway if the originating UFMI maps to within the at least one range of originating UE UFMIs and the target identifier maps to within the at least one range of target UE UFMIs.

15. The method as recited in claim 12, wherein in the defining step, the at least one text record includes a calling restriction for calls from an originating UE homed in a first specified home domain to a target UE homed in a second specified home domain, and wherein the restricting step includes restricting the call by the gateway if the originating UE is homed in the first specified home domain and the target UE is homed in the second specified home domain.

16. The method as recited in claim 12, wherein in the defining step, the at least one text record includes a calling restriction for calls from an originating UE served by a first specified domain server to a target UE served by a second specified domain server, and wherein the restricting step includes restricting the call by the gateway if the originating UE is served by the first specified domain server and the target UE is served by the second specified domain server.

17. The method as recited in claim 12, wherein in the defining step, the at least one text record includes at least one originating UE calling restricting selected from the group of a specified originating UFMI range, a specified originating home domain, and a specified originating server, and at least one target UE calling restricting selected from the group of a specified target UFMI range, a specified target home domain, and a specified target server, wherein the restricting step includes restricting the call by the gateway if the originating UE is operating under any one of the originating UE calling restrictions and the target UE is operating under any one of the target UE calling restrictions.

18. The method as recited in claim 12, wherein in the defining step, the at least one text record includes at least one record having a shortcut key, wherein the shortcut key indicates that a given restriction that applies to a call from a first UE to a second UE also applies to a call from a second UE to a first UE.

19. The method as recited in claim 12, wherein in the defining step, the at least one text record defines a calling restriction for at least one range of restricted UE UFMI ranges, the at least one range defining a sequence of UFMIs of UEs, wherein the restricting step includes restricting the call by the gateway if at least one of the originator UFMI and the target UFMI maps to the at least one range of restricted UE UFMIs.

20. A gateway for implementing calling restrictions between a first and a second communication network connected via the gateway, the gateway configured to:
receive a call from the first communication network for a target identifier in the second communication network,
make a query to a repository to download at least one text record of a set of call control parameters from the repository, and
restrict the call from the first communication network to the second communication network in accordance with the at least one text record.
